(19) United States
(12) Patent Application Publication
(10) Pub. No.: US 2011/0320459 A1
(43) Pub. Date: Dec. 29, 2011

(54) TERM IDENTIFICATION METHOD AND APPARATUS

(75) Inventor: Alastair Chisholm, Edinburgh (GB)

(73) Assignee: ITI SCOTLAND LIMITED, Glasgow (GB)

(21) Appl. No.: 12/735,851

(22) PCT Filed: Feb. 20, 2009
(86) PCT No.: PCT/GB2009/050173

§ 371 Date: Jan. 18, 2011

(30) Foreign Application Priority Data
Feb. 20, 2008 (GB) 0803075.1
Oct. 17, 2008 (GB) 0819075.3

(51) Int. Cl. G06F 17/30

(52) U.S. Cl. 707/748; 707/E17.084

(57) ABSTRACT

A method of assigning an identifier to a mention of an entity in a document carried out by computing apparatus including a display and one or more user operable input devices. A plurality of candidate identifiers are received from a term identification module in respect of a mention of an entity in a document, each candidate identifier being a reference to an entity in connection with which entity property data is stored in one or more entity databases. A list is displayed in a first region of the display, the list having a plurality of user-selectable entries, each entry in the list concerning the entity referred to by one of the said plurality of candidate identifiers, each entry comprising properties of the respective entity. At least one of the said properties is retrieved from the said one or more entity databases. In response to the selection by a user of an entry in the list, additional properties of the entity which the selected entry concerns are displayed in a second region of the display, the additional properties being retrieved at least in part from the one or more said databases. Responsive to an identifier assignment instruction received from a user in connection with a selected entity which a list entry concerns, an identifier of the selected entity is assigned as identifier of the mention of the entity. Filters are provided to enable a user to restrict the entities in connection with which a list entry is provided to those which fulfil user specified criteria. The properties which are displayed in the first and second region of the display are customisable for different domains and applications.

### FIELD OF THE INVENTION

The invention relates to methods and apparatus for aiding a human curator in assigning an identifier to a mention of an entity in a text document.

### BACKGROUND TO THE INVENTION

Term identification is the process of assigning an identifier to a term in a body of data and the present invention relates to term identification methods for assigning an identifier to a mention of an entity in a text document. The invention will be illustrated with examples from the field of assigning identifiers to mentions of entities in biomedical text documents, but is equally applicable to the analysis of text documents concerning other domains of knowledge.

Typically, a mention of an entity will be identified with reference to an ontology which includes data concerning entities. By a mention of an entity we refer to the character string in a text document which denotes an entity. By an entity we refer to the concept of a specific named entity which may be mentioned in text documents and which is included within an ontology or other database of entities, typically along with properties of the entity. For example, RefSeq (http://www.ncbi.nlm.nih.gov/RefSeq/) includes an entry for the human insulin receptor substrate 1 gene indexed under identifier NP_{—}005535. Insulin receptor substrate 1 [Homo sapiens] is an entity.

However, the string “insulin receptor substrate 1” or the string “IRS1” in a text document would be a mention of an entity, and if this mention of an entity was in a context which implied that the string denotes the gene coding for human insulin receptor substrate 1 then this mention of an entity should be assigned the identifier NP_{—}005535 or another identifier which refers to insulin receptor substrate 1 [Homo Sapiens]. An ontology typically includes data concerning properties of entities and identification data such as an accession number or other unique identifier, as well as a canonical text representation of each entity in the ontology.

There are numerous applications in which the assignment of an identifier to a mention of an entity is important. The allocation of an identifier to a mention of an entity in a text document may be one part of computer-implemented information extraction from the text document. It may be necessary to successfully identify mentions of entities to complete further information extraction steps, such as the identification of relations between mentions of entities. Databases of the entities mentioned within a text document can be used to search for text documents including mentions of entities with a specific identifier, or to carry out more complex data mining of text documents.

WO 05/017692 (Cognia Corporation) discloses a system in which human curators read biomedical text documents and assign identifiers to biological entities which the biomedical text document concerns, with assistance from a computer-user interface which ensures that their identifications and other annotations are standardised by reference to an ontology. The resulting identification data is included in a queriable database, with numerous scientific applications. This procedure benefits from the input of skilled human curators, however the time which must be spent by those curators is substantial, which limits the cost-effectiveness of this procedure.

Considerable research has been carried out into automated, computer-implemented term identification. Automated computer-implemented term identification enables the rapid identification of mentions of entities in many text documents, however automated computer-implemented term identification remains an imperfect science which can severely limit the usefulness of the resulting data. The quality of computer-implemented term identification depends very much on the type of data and the terms which are to be identified. When analysing biomedical text documents to identify genes, proteins and polynucleic acids, it can be especially difficult for computer-implemented term identification modules to correctly disambiguate by species and isoform.

WO 2007/116204 (ITI Scotland Limited) discloses an information extraction system and method, including a computer-user interface, which enables a human curator to make use of automated computer-implemented information extraction methods to speed up and/or improve the identification of mentions of entities in a text document while still allowing the final identification to be authorised by a human curator. This enables the human curator to benefit from automated, computer-implemented information extraction technology, including a term identification module, despite the inherent limitations of automated, computer-implemented information extraction.

The invention aims to provide improved methods to enable a human curator to assign identifiers to mentions of entities in a text document, whilst receiving assistance from an imperfect automated computer-implemented term identification module.

### SUMMARY OF THE INVENTION

According to a first aspect of the present invention there is provided a method of assigning an identifier to a mention of an entity in a document, the method comprising the steps carried out by computing apparatus including a display and one or more user operable input devices of:
(i) in respect of a mention of an entity in a document, receiving a plurality of candidate identifiers of the mention of an entity from a term identification module, each candidate identifier being a reference to an entity in connection with which entity property data is stored in one or more entity databases;
(ii) displaying, in a first region of the display, a list having a plurality of user-selectable entries, each entry in the list concerning the entity referred to by one of the said plurality of candidate identifiers, each entry comprising properties of the respective entity, at least one of the said properties being retrieved from the said one or more entity databases;
(iii) in response to the selection by a user of an entry in the list, displaying, in a second region of the display, additional properties of the entity which the selected entry concerns, the additional properties being retrieved at least in part from the one or more said databases; and
(iv) responsive to an identifier assignment instruction received from a user in connection with a selected entity which a list entry concerns, assigning an identifier of the selected entity as identifier of the mention of the entity.

Thus, the resulting user interface enables a human curator to work with an imperfect computer-implemented term identification module, to help them assign their preferred identifier to an individual mention of an entity, in a time-efficient fashion. The method typically includes providing the user with the opportunity to change their selection of an entry from the list and updating the second region of the display in response. By providing a list comprising information concerning a plurality of entities, rather than simply a single entity, such as the single entity which the term identification module considered to be most likely to correspond to the mention of an entity, better use can be made of an imperfect term identification module.

The method enables a curator to rapidly view useful data concerning one or more entities which may correspond to the curator's preferred identification of the mention of the entity, to facilitate the identification process, whilst reducing or removing their need to refer to entirely separate sources, such as search engines, for additional information concerning entities, which would slow down the curation process. Even if a human curator will require time to decide which is their preferred identifier of a mention of an entity, by viewing a list of properties of the entities to which the candidate identifiers refer, they can rapidly ascertain whether the term identification module has produced appropriate candidates. By enabling a curator to select an entry in the list and rapidly retrieve more information concerning the entities which individual list entries concern, the human curator can assess the additional property information which enables them to correctly identify the mention of an entity. The resulting convenient access to additional property information can help a curator disambiguate between very similar entities, such as entities from different species, or which are isoforms.

The entry in the list may be selectable by operating a pointing device (such as a mouse) to move a pointer over a region of the display including the entry in the list. The selection of the entry in the list may, or may not, also require a further user actuated selection event, such as clicking a mouse button.

Typically, the identifier which is assigned as identifier of the mention of the entity is the said candidate identifier which refers to the selected entity, although it could be an alternative identifier for the selected entity, for example, an alternative identifier of the selected entity retrieved from the one or more entity databases.

Preferably, the term identification module calculates, in respect of each of the plurality of candidate identifiers, a probability parameter which is related to the probability that the entity to which the candidate identifier refers is the entity denoted by the mention of an entity. Preferably, the step of displaying the list includes taking into account the probability parameters of the candidate identifiers to which each entry relates, to order the entries according to the probability parameters of the candidate identifiers to which they relate, or to provide a visual indication related to the probability parameter of the candidate identifier to which each entry relates.

The second region of the display may initially display additional properties of the entity which the term identification module has determined that the mention of an entity is most likely to be. Alternatively, there may not be a second region of the display which displays additional properties of an entity until the user has selected an entry from the list.

At least one property which each entry in the list comprises is preferably an identifier of the entity which the entry concerns, for example, a unique identification number of an entity in the one or more databases (e.g. an accession number), or a canonical name of the entity. Accordingly, each entry in the list may comprise the respective candidate identifier.

Preferably, the properties displayed in the first region of the display are determined by editable configuration parameters, to enable the selection of properties for display from a larger group of properties in respect of which information is stored in the one or more databases. Preferably, the properties displayed in the second region of the display are determined by configuration parameters, which are changeable to select properties which are displayed from a larger group of properties in respect of which there is information in the one or more databases.

As well as displaying additional properties of an entity in the second region of the display, the method may include displaying the same properties which are, or have been, displayed in the first region of a display in relation to the entity which the selected entry concerns, within the second region of the display.

Preferably, the one or more entity databases are one or more ontologies.

Preferably, the method comprises restricting the entities in connection with which a list entry is provided, to those which fulfil one or more user selectable criteria, responsive to a user selection. Accordingly, the method preferably comprises displaying a user-selectable user interface element which is selectable by a user to specify the one or more user specified criteria. The user-selectable user interface element preferably displays one or more user selectable properties of an entity, for example in a menu, such as a drop-down menu. The method may comprise restricting the entities in connection with which a list entry is provided to entities having the selected property

The method may comprising providing a user-selectable user interface element which is selectable to restrict the entities in respect of which a list entry is displayed to those which have a property in common with the entity which the currently selected entry concerns, in connection with which additional properties are displayed in the second region of the display. In this case, the method preferably includes restricting the entities in respect of which a list entry is displayed accordingly, responsive to selection of the said user-selectable user interface element.

Preferably, the method includes the step of receiving a text document and analysing the document using a term identification module, to determine the plurality of candidate identifiers of one or more mentions of entities within the document. The term identification module preferably employs a trainable statistical model, such as a Maximum Entropy Markov Model or a Hidden Markov Model.

The selected entity in connection with which an identifier assignment instruction is received is typically the entity which the selected list entry concerns.

The method may also comprise displaying the document to a user, using the display. This is preferred, so that the user can view the document, and then the list of user-selectable entries, conveniently on a display. The second region of a display is preferably visible at the same time as the first region of a display.

The text documents may be biomedical text documents. In this case, the entities typically comprise one or more of proteins, genes, polynucleic acids, macromolecular structures, complexes, organisms, organelles.

The invention extends in a second aspect to computing apparatus comprising a display and one or more user input devices, which computing apparatus is operable to perform a method according to the first aspect.

According to a third aspect of the present invention, there is provided a computer program code which, when executed on computing apparatus having a display and one or more user input devices, causes the said computing apparatus to perform the method of the first aspect. The computing apparatus typically further comprises operating system software, display driver software, and input device driver software.

In a fourth aspect, the invention extends to a computer readable carrier storing program code according to the third aspect of the present invention.

### DESCRIPTION OF THE DRAWINGS

An example embodiment of the present invention will now be illustrated with reference to the following Figures in which:

FIG. 1 is a schematic diagram of computing apparatus suitable for carrying out to the method of the present invention;

FIG. 2 is a screen-shot of a user-interface according to the present invention;

FIG. 3 is a screen-shot of part of the user-interface of FIG. 2, with a drop-down menu;

FIG. 4 is a screen-shot of a further part of the user-interface of FIG. 2; and

FIG. 5 is a flow chart of an assisted curation procedure.

### DETAILED DESCRIPTION OF AN EXAMPLE EMBODIMENT

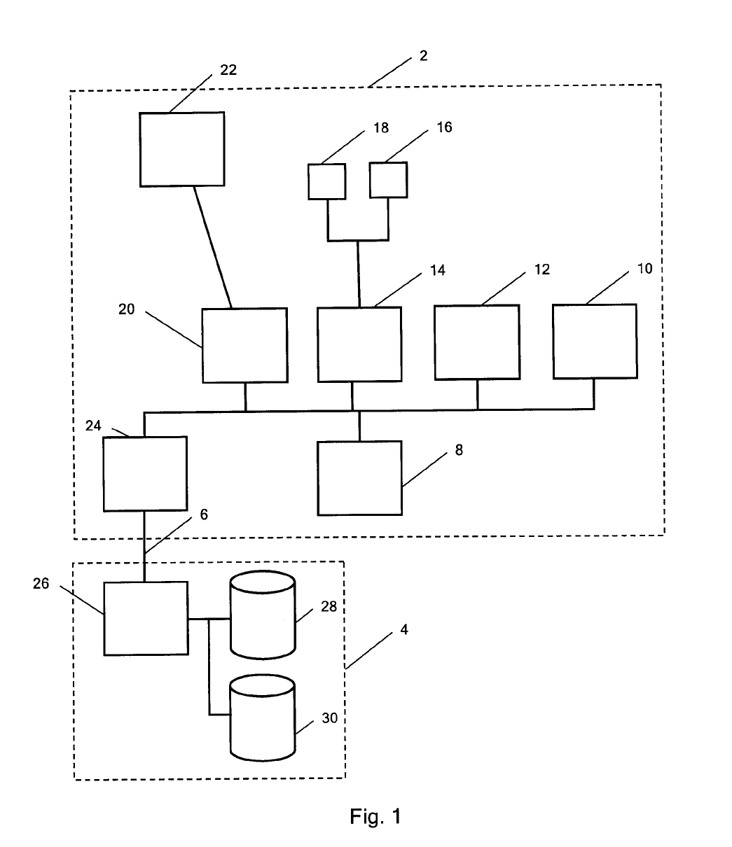

With reference to FIG. 1, computing apparatus comprises a client computer 2 and a server 4 connected via a network 6. The server functions to carry out information extraction from text documents, such as biomedical literature text documents, and to transmit the analysed document and candidate identifiers of entities to the client computer, for presentation to a human curator.

The client computer includes CPU 8 and one or more buses 9, through which the CPU communicates with external RAM memory 10; a hard disk 12; input device interfaces 14 used to drive input peripherals such as a keyboard 16 and mouse 18; a video display driver 20 which transmits a video signal to a display 22; and a network interface 24, such as an ethernet adapter card. The hard disk stores operating system software and device driver software, which is loaded into RAM memory when required, and used to provide a user-interface by specifying images to be displayed on the display, and receiving signals from a user, using the input peripherals. The operating system software is a windowing operating system operable to cause the client computer to produce a video signal which is interpretable by a display to provide images denoting user interface elements, such as text, images, windows, menus and so forth, and to interpret instructions from a user by way of the input peripherals.

The server comprises at least one CPU 26 for carrying out term identification and other natural language processing steps. The server includes data storage which retrievably stores a database of text documents 28, and an ontology database 30, including data concerning entities, and properties of those entities. Each entity is indexed within the database with reference to an accession number, which functions as an identifier of that entity. The data concerning each entity includes a canonical form of that entity, in the form of an alphanumeric string. Although this example embodiment makes use of a client computer and a separate server, one skilled in the art will appreciate that all steps may be carried out by a single computer, or that the various steps at may be distributed between further computers.

The server is operable to receive a text document and to analyse it using a natural language processing pipeline in the form of a series of software modules which act in turn on the text document. The natural language processing pipeline, which is described further below, includes a term identification module which is operable, in respect of each mention of an entity which is found in the text document, to output a group of candidate identifiers of that mention of an entity, along with a parameter which is related to the probability that that identifier it is the correct identifier for the individual mention of an entity.

The client computer displays a received text document on the display, with one or more mentions of entities which have been identified within the text document by the natural language processing pipeline highlighted therein, at the location within the text document where they have been identified. A curator may select an individual mention of an entity for curation, for example by pointing to it with a computer mouse, or other pointing device, and pressing a button. The curator aims to assign to the mention of an entity an identifier of an entity in the ontology which, in their opinion, the mention of an entity represents.

Once an individual mention of an entity has been selected for curation, the group of candidate identifiers of that individual mention of an entity is analysed and properties of the entities to which each of the candidate identifiers refer are retrieved from the ontology. In this example, the mention of an entity denotes a gene. An assisted look up window 100 is displayed, potentially obscuring at least part of the displayed text document. The assisted look up window includes a box 102, functioning as the first region of the display, which includes a list 104, made up from a plurality of entries 104. The list may be longer than can be displayed in the first region at once, and a scroll bar 106 is provided to enable a user to view entries which are lower down, or higher up the list, as appropriate.

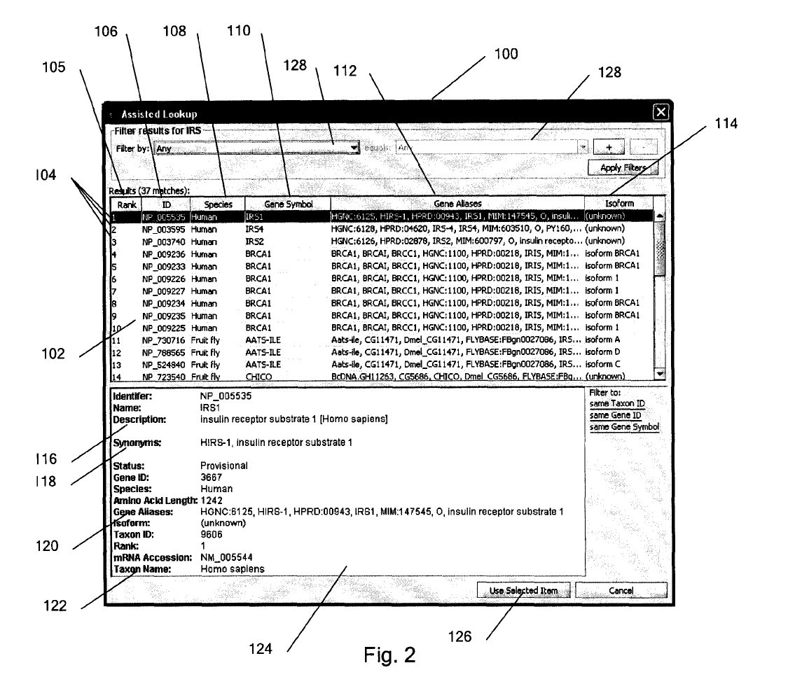

Each entry concerns the entity referred to by one of the candidate identifiers in the group of candidate identifiers. Each entry includes a series of properties of the entity which the entry concerns, retrieved from the ontology. The properties which are displayed are determined by configuration parameters, dependent on the requirements of the individual curator, and the subject matter of the text documents which are to be reviewed by the curator. The properties are laid out in columns. In the example illustrated in FIG. 2, these properties are a rank number 105, discussed further below, a candidate identifier in the form of an accession number 106, which uniquely identifies the gene which the entry concerns, the species of the organism where the gene occurs 108, an alphanumeric symbol which is a canonical representation of the name of the gene 110, a series of common aliases of the gene 112, and an identifier of the precise isoform 114 of the entity to which the respective candidate identifier refers.

The entries within the list are ranked in decreasing order of the probability that the entity which the entry concerns will be considered by a curator to be the entity to which that mention of an entity relates. The probabilities are determined by the term identification module, when it determines the group of candidate identifiers and the entry concerning the most likely candidate identifier is displayed first. At any given time, a single entry is selected. Additional properties, such as description 116, synonyms 118, gene aliases 120 and taxon name 122, of the entity which the selected entry concerns are displayed in a second box, functioning as the second region of the screen 124. The additional properties are retrieved from the ontology when required. The user can at any time select an alternative entry by conventional user interface methods, such as pointing with a pointing device and clicking, whereupon the second region of the screen is updated to display additional properties of the entity which the newly selected entry concerns.

As a result, a curator can rapidly view a list of candidate identifiers of a mention of an entity and the entities to which those identifiers refer. Basic information about each entity to which these candidate identifiers refer is displayed in the first region of the display. The curator can then select an entity, whereupon additional properties of the selected entity are displayed in the second region of the display. This enables the curator to rapidly view the information which they need to assign the correct identifier to the mention of an entity, without having to go to a separate information source, such as a search engine. This can speed up the curation process, and potentially improve its accuracy.

Once the curator has decided on the correct identifier that the mention of an entity, they can use a user interface elements, in this case a selectable button 126, to indicate that an identifier associated with the selected entry should be assigned to the mention of an entity. At this stage, the window including the first and second regions of the display is typically deactivated, or entirely removed by the windowing operating system, until another mention of an entity is selected by the curator.

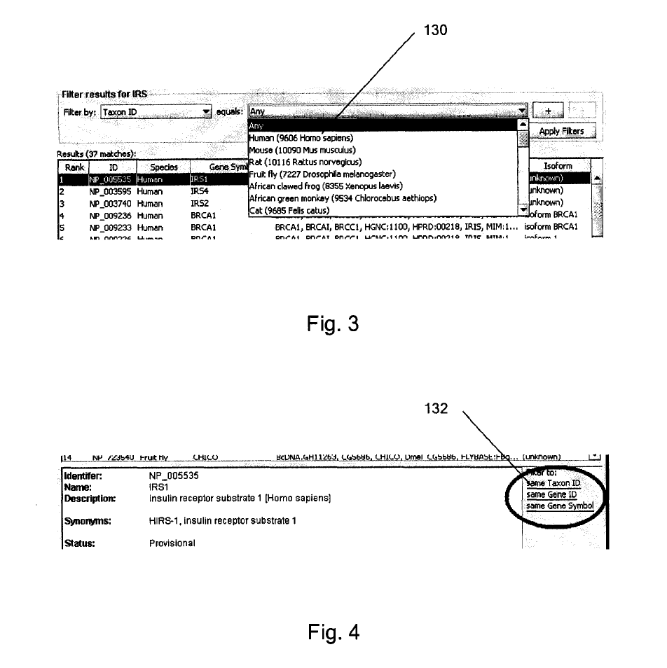

To further improve the efficiency of the assisted look up procedure, two filtering mechanisms are provided. In a first filtering mechanism, a third region of the display includes a user-interface element, such as a drop-down menu 128, which enables a user to specify one or more filter criteria, responsive to which the list is restricted to only include entries in respect of the entities which have properties, stored in the ontology, which fulfil the filter criteria. For example, FIG. 3 illustrates a drop-down menu from which a user can select a species 130. Once a species is selected, the list is amended to only display entries concerning genes from that species. Typically, a filter is provided to enable a user to filter depending on any of the properties displayed in the first or second regions of the display. In a second filtering mechanism, illustrated in FIG. 4, user-interface elements in the form of selectable text 132 or icons are provided which enable a curator to limit the entries displayed in the list, to only those entries which concern entities having one or more specified properties, stored in the ontology, in common with the entity to which the selected entry relates, when the user-interface element is selected. In this case, selecting “same Taxon ID” will limit the entries displayed in the list to only those which concern entities having the same Taxon ID property in the ontology and selecting “same Gene ID” will limit the entries displayed in the list to only those which concern entities having the same Gene ID property. We have found that this speeds up the process of enabling a human curator to find their preferred identifier of the mention of an entity.

As well as enabling a curator to select an identifier of the mention of an entity, the user interface preferably also enables a curator to add new entities, with new identifiers, to the ontology if they discover a mention of an entity which denotes an entity which is not in the ontology.

### Information Extraction

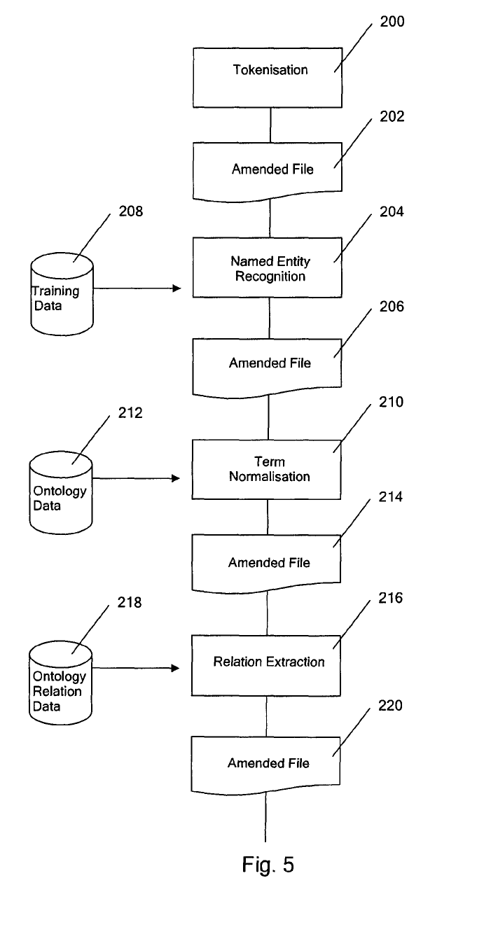

Computer software which is suitable for carrying out information extraction and preparing the group of candidate identifiers concerning individual mentions of an entity will now be described with reference to FIG. 5, which is a flow diagram of the steps involved in an information extraction procedure. A tokenisation software module 200 accepts a cached text document file in XML format as input and outputs an amended XML file 202 including tokenisation mark-up. A named entity recognition software module 204 receives the amended XML file as input and outputs a further amended XML file 206 in which individual mentions of entities have been recognised and marked-up. The named entity recognition software module has been previously trained on training data 208. The named entity recognition software module comprises a plurality of different prior files. The amended XML file is then processed by a term identification software module 210 which also takes ontology data 212 as an input, outputting a further amended XML file 214 in which individual mentions of entities have been labelled by reference to a group of 10 to 20 candidate identifiers. Each candidate identifier is a reference to an entity stored in the ontology data, and the group of candidate identifiers functions as the plurality of candidate identifiers. As well as a group of candidate identifiers of each individual mention of an entity, the term identification software module outputs a parameter related to the calculated probability that the respective candidate identifier refers to what will be considered to be the correct entity which that mention of an entity represents. As well as a group of candidate identifiers of each individual mention of an entity, the amended output XML file 216 also includes, in respect of every string which has been identified as representing a named entity at least once in the text document, a list of identifiers of several hundred entities which the term identification software module considers to potentially be represented by respective string.

The output XML file may then be processed by a relation extraction software module 218 which outputs an annotated XML file 220 including data concerning relations which have been identified in the document file.

Tokenisation, named entity recognition, term identification and relation extraction are each significant areas of ongoing research and software for carrying out each of these stages is well known to those skilled in the field of natural language processing. In an exemplary information extraction pipeline, input documents in a variety of formats, such as pdf and plain text, as well as XML formats such as the NCPI/NLM archiving and interchange DTD, are converted to a simple XML format which preserves some useful elements of a document structure and formatting information, such as information concerning superscripts and subscripts, which can be significant in the names of proteins and other classes of biomedical entities. Documents are assumed to be divided into paragraphs, represented in XML by <p> elements. After tokenisation, using the default tokeniser from the LUCENE project (the Apache Software Foundation, Apache Lucene, 2005) and sentence boundary detection, the text in the paragraphs consists of <s> (sentence) elements containing <w> (word) elements. This format persists throughout the pipeline. Additional information and annotation data added during processing is generally recorded either by adding attributes to words (for example, part-of-speech tags) or by standoff mark-up. The standoff mark-up consists of elements pointing to other elements by means of ID and IDREF attributes. This allows overlapping parts of the text to be referred to, and standoff elements can refer to other standoff elements that are not necessarily contiguous in the original text. Named entities are represented by <ent> elements pointing to the start and end words of the entity. Relations are represented by a <relation> element with <argument> children pointing to the <ent> elements participating in the relation. The standoff mark-up is stored within the same file as the data, so that it can be easily passed through the pipeline as a unit, but one skilled in the art will recognise that the mark-up may be stored in other documents.

Input documents are then analysed in turn by a sequence of rule-based pre-processing steps implemented using the LT-TTT2 tools (Grover, C., Tobin, R. and Matthews, M., Tools to Address the Interdependence between Tokenisation and Standoff Annotation, in Proceedings of NLPXML2-2006 (Multi-dimensional Markup in Natural Language Processing), pages 19-26. Trento, Italy, 2006), with the output of each stage encoded in XML mark-up. An initial step of tokenisation and sentence-splitting is followed by part-of-speech tagging using the C&C part-of-speech tagger (Curran, J. R. and Clark, S., Investigating GIS and smoothing for maximum entropy taggers, in Proceedings of the 11th Meeting of the European Chapter of the Association for Computational Linguistics (EACL-03), pages 91-98, Budapest, Hungary, 2003), trained on the MedPost data (Smith, L., Rindflesch, T. and Wilbur, W. J., MedPost: a part-of-speech tagger for biomedical text. Bioinformatics, 20(14):2320-2321, 2004).

A lemmatiser module obtains information about the stems of inflected nouns and verbs using the Morpha lemmatiser (Minnen, G., Carroll, J. and Pearce, D., Robust, applied morphological generation, in Processing of 1st International Natural Language Generation Conference (NLG '2000), 2000). Information about abbreviations and their long forms (e.g. B cell linker protein (BLNK)) is computed in a step which calls Schwartz and Hearst's ExtractAbbrev program (Schwartz, A. S. and Hearst, M. A. Identifying abbreviation definitions in biomedical text, in Pacific Symposium on Biocomputing, pages 451-462, 2003). A lookup step uses ontology information to identify scientific and common English names of species for use downstream in the Term Identification component. A final step uses the LT-TTT2 rule-based chunker to mark up noun and verb groups and their heads (Grover, C. and Tobin, R., Rule-Based Chunking and Reusability, in Proceedings of the Fifth International Conference on Language Resources and Evaluation (LREC, 2006), Genoa, Italy, 2006.)

A named entity recognition module is used to recognise proteins, although one skilled in the art will recognise that other classes of entities such as protein complexes, fragments, mutants and fusions, genes, methods, drug treatments, cell-lines etc. may also be recognized by analogous methods. The named entity recognition module was a modified version of a Maximum Entropy Markov Model (MEMM) tagger developed by Curran and Clark (Curran, J. R. and Clark, S., Language independent NER using a maximum entropy tagger, in Walter Daelemans and Miles Osborne, editors, Proceedings of CoNLL-2003, pages 164-167, Edmonton Canada, 2003, hereafter referred to as the C&C tagger) for the CoNLL-2003 shared task (Tiong Kim Sang, E. F. and De Mulder, F., Introduction to the CoNLL-2003 shared task: Language-independent named entity recognition, in Walter Daelemans and Miles Osborne, editors, Proceedings of CoNLL-2003, pages 142-147, Edmonton, Canada, 2003).

The vanilla C&C tagger is optimised for performance on newswire named entity recognition tasks such as CoNLL-2003, and so a tagger which has been modified to improve its performance on the protein recognition task is used. Extra features specially designed for biomedical text are included, a gazetteer containing possible protein names is incorporated, an abbreviation retagger ensures consistency with abbreviations, and the parameters of the statistical model have been optimised. The addition features which have been added using the C&C experimental feature option are as follows: CHARACTER: A collection of regular expressions matching typical protein names; WORDSHAPE: An extended version of the C&C ‘wordtype’ orthographic feature; HEADWORD: The head word of the current noun phrase; ABBREVIATION: Matches any term which is identified as an abbreviation of a gazetteer term in this document; TITLE: Any term which is seen in a noun phrase in the document title; WORDCOUNTER: Matches any non-stop word which is among the ten most commonly occurring in the document; VERB: Verb lemma information added to each noun phrase token in the sentence; FONT: Text in italics and subscript contained in the original document format. NOLAST: The last (memory) feature of the C&C tagger was removed. The modified C&C tagger has also been extended using a gazetteer in the form of a list of proteins derived from RefSeq (http://www.ncbi.nlm.nih.gov/RefSeq/), which was pre-processed to remove common English words and tokenised to match the tokenisation imposed by the pipeline. The gazetteer is used to tag the proteins in the document and then to add the bio tag corresponding to this tagging and the bigram of the previous and current such bio tags as C&C experimental features to each word. Cascading is carried out on groups of entity instances (e.g. one model for all entity instances, one for specific entity type, and combinations). Subsequent models in the cascade have access to the guesses of previous ones via a GUESS feature. The C&C tagger corresponds to that described in B. Alex, B. Haddow, and C. Grover, Recognising nested named entities in biomedical text, in Proceedings of BioNLP 2007, p. 65-72, Prague, 2007, the contents of which are incorporated herein by virtue of this reference.

In use, the C&C tagger employs a prior file which defines parameters which affect the function of the tagger. A plurality of different prior files are provided to enable named entity recognition to be carried out with different balances between precision and recall, thereby enabling information extraction to take place in a plurality of different operating modes in which different data is extracted for subsequent review by the human creator. The “tag prior” parameter in each prior file is selected in order to adjust the entity decision threshold in connection with each of the bio tags and thus modify the decision boundary either to favour precision over recall or recall over precision.

The abbreviation retagger is implemented as a post-processing step, in which the output of the C&C tagger was retagged to ensure that it was consistent with the abbreviations predicted by the Schwarz and Hearst abbreviation identifier. If the antecedent of an abbreviation is tagged as a protein, then all subsequent occurrences of the abbreviation in the same document are tagged as proteins by the retagger.

The term identification software module employs four key components. The first component is a species tagger which identifies the most likely species of individual mentions of entities in a document by looking at the context of each mention of an entity. The species tagger focuses particularly on clues from species-indicating words, such as “human” or “mouse”. The species tagger makes use of a Weka implementation of the Support Vector Machines algorithm (www.cs.waikato.ac.nz.^{˜}ml/weka, Witten, I. H. and Frank, E. (2005), Data Mining: Practical machine learning tools and techniques, second edition, Morgan Kaufmann, San Francisco, 2005), which has been trained on manually annotated data. In one implementation, each training instance is represented as a features-value pair, where features are TF-IDF weighted word lemmas that co-occur with the protein mentioned in a context window of size 50, and a value is the species which has been assigned to the protein mentioned by a human annotator. The species tagger may output not only the most likely identified species, but also a number of alternative species.

After species identification, both a fuzzy matcher and a rule-based matcher are invoked, each of which independently identifies surface forms which are similar to the mention of an entity, which are known synonyms of entities, within the ontology. The output from this stage is a series of suitcases, one of which is provided for each surface form. The suitcase concerning each surface form includes identifiers of entities from the ontology which have a synonym which is the same as the respective surface form.

A ranking module then reads the suitcases and produces a ranked list of candidate identifiers for each mention of an entity in the text document. The ranking module can employ a heuristic rule which favours identifiers which have the lowest numerical value in the ontology; which takes into account the number of references to the identifier in the RefSeq ontology; and which also takes into account whether an instance of an entity is identical or similar to the canonical form of the entity to which a candidate identifier relates, rather than a synonym of the entity; and, where relevant, the amino acid length of a protein to which a candidate identifier relates and/or the number of the isoform to which a candidate identifier relates (that is to say, the numerical index in entities which exist in isoforms, such as CK-1, CK-2 and CK-3). Applying standard experiments, familiar to one skilled in the art, results in determining a weighting for these various factors and an ordering for processing them that produces the best performance for any given set of training data.

The result is a bag of typically up to 15 candidate identifiers output in connection with each mention of an entity. The candidate identifiers in each bag are those which are considered to be the most likely identifiers of each individual mention of an entity and they are provided in a ranked order. When providing a list of entries in the first region of the display, the entries are provided initially in the ranked order of the respective candidate identifier from the bag of candidate identifiers concerning that mention of an entity. To increase the number of entries in the list which is provided to a curator in the first region of the display, additional potentially relevant candidate identifiers may be obtained from the suitcase concerning the surface form which corresponds to each mention of an entity.

Further modifications and variations may be made within the scope of the invention herein disclosed.

1. A method of assigning an identifier to a mention of an entity in a document, the method comprising the steps carried out by computing apparatus including a display and one or more user operable input devices of:
(i) in respect of a mention of an entity in a document, receiving a plurality of candidate identifiers of the mention of an entity from a term identification module, each candidate identifier being a reference to an entity in connection with which entity property data is stored in one or more entity databases;
(ii) displaying, in a first region of the display, a list having a plurality of user-selectable entries, each entry in the list concerning the entity referred to by one of the said plurality of candidate identifiers, each entry comprising properties of the respective entity, at least one of the said properties being retrieved from the said one or more entity databases;
(iii) in response to the selection by a user of an entry in the list, displaying, in a second region of the display, additional properties of the entity which the selected entry concerns, the additional properties being retrieved at least in part from the one or more said databases; and
(iv) responsive to an identifier assignment instruction received from a user in connection with a selected entity which a list entry concerns, assigning an identifier of the selected entity as identifier of the mention of the entity.

2. A method according to claim 1, wherein a probability parameter is received from the term identification module in respect of each of the plurality of candidate identifiers, wherein the said probability parameters are related to the probability that the entity to which the candidate identifier refers is the entity denoted by the mention of an entity, and wherein the step of displaying the list includes taking into account the probability parameters of the candidate identifiers to which each entry relates, to order the entries according to the probability parameters of the candidate identifiers to which they relate, or to provide a visual indication related to the probability parameter of the candidate identifier to which each entry relates.

3. A method according to claim 2, wherein the second region of the display initially displays additional properties of the entity which the term identification module has determined to be most likely to be the preferred identifier of a mention of an entity.

4. A method according to claim 1, wherein at least one property which each entry in the list comprises is an identifier of the entity which the entry concerns.

5. A method according to claim 1, wherein the properties displayed in the first region of the display are determined by editable configuration parameters, to enable the selection of properties for display from a larger group of properties in respect of which information is stored in the one or more databases.

6. A method according to claim 1, wherein the method comprises restricting the entities in connection with which a list entry is provided, to those which fulfil one or more user selectable criteria, responsive to a user selection.

7. A method according to claim 6, wherein the method comprises displaying a user-selectable user interface element which is selectable by a user to specify the one or more user specified criteria.

8. A method according to claim 7, wherein the user-selectable user interface element displays one or more user selectable properties of an entity, for example in a menu, such as a drop-down menu and the method comprises restricting the entities in connection with which a list entry is provided to entities having the selected property

9. A method according to claim 6, wherein the method comprises providing a user-selectable user interface element which is selectable to restrict the entities in respect of which a list entry is displayed to those which have a property in common with the entities which the currently selected entry concerns.

10. A method according to claim 1, including the step of receiving a text document and analysing the document using a term identification module, to determine the plurality of candidate identifiers of one or more mentions of entities within the document.

11. A method according to claim 1, wherein the selected entity in connection with which an identifier assignment instruction is received is the entity which the selected list entry concerns.

12. A method according to claim 1, wherein the text documents are biomedical text documents and the entities comprise one or more of proteins, genes, polynucleic acids, macromolecular structures, complexes, organisms, and organelles.

13. A method according to claim 1, wherein the identifier which is assigned as identifier of the mention of the entity is the said candidate identifier which refers to the selected entity.

14. Computing apparatus comprising a display and one or more user input devices, which computing apparatus is operable to perform the method of claim 1.

15. Computer program code which, when executed on computing apparatus having a display and one or more user input devices, causes the said computing apparatus to perform a method according to claim 1.

16. A computer readable carrier storing program code according to claim 15.
